(19) United States
(12) Patent Application Publication
(10) Pub. No.: US 2006/0031628 A1
(43) Pub. Date: Feb. 9, 2006

(54) Buffer management in a network device without SRAM

(76) Inventor: Suman Sharma, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/859,631

(22) Filed: Jun. 3, 2004

(51) Int. Cl. G06F 12/16; G06F 15/16

(52) U.S. Cl. 711/105; 709/253

(57) ABSTRACT

A technique for performing buffer management on a network device without using static random access memory (SRAM). In one embodiment, a software-based buffer management scheme is used to allocate metadata buffers and packet buffers in one or more dynamic random access memory (DRAM) stores. As metadata buffers are allocated, pointers to those buffers are entered into a scratch ring. The metadata buffers are assigned for corresponding packet-processing operations. In one embodiment, metadata buffers are added in groups. A freed buffer count is maintained for each group, wherein a new group of buffers may be allocated if all buffers for the group have been freed. In one embodiment, the technique is facilitated by an application program interface (API) that contains buffer management functions that are callable by packet-processing code, wherein the are names and parameters of the API functions are identical to similar functions used for conventional buffer management operations employing SRAM.

### FIELD OF THE INVENTION

The field of invention relates generally to network equipment and, more specifically but not exclusively relates to a technique of managing buffers in a network device without employing static random access memory (SRAM).

### BACKGROUND INFORMATION

Network devices, such as switches and routers, are designed to forward network traffic, in the form of packets, at high line rates. One of the most important considerations for handling network traffic is packet throughput. To accomplish this, special-purpose processors known as network processors have been developed to efficiently process very large numbers of packets per second. In order to process a packet, the network processor (and/or network equipment employing the network processor) needs to extract data from the packet header indicating the destination of the packet, class of service, etc., store the payload data in memory, perform packet classification and queuing operations, determine the next hop for the packet, etc.

Under a typical packet processing scheme, a packet (or the packet's payload) is stored in a “packet” buffer, while “metadata” used for processing the packet is stored elsewhere in a metadata buffer. Whenever a packet-processing operation needs to access the packet or metadata, a memory access operation is performed. Each memory access operation adds to the overall packet-processing latency.

Ideally, all memory accesses would be via the fastest scheme possible. For example, modern on-chip (i.e., on the processor die) static random access memory (SRAM) provides access speeds of 10 nanoseconds or less. However, this type of memory is very expensive (in terms of chip real estate and chip yield), so the amount of on-chip SRAM memory provided with a processor is usually very small. Typical modern network processors employ a small amount of on-chip SRAM for scratch memory and the like.

The next fastest type of memory is off-chip SRAM. Since this memory is off-chip, it is slower to access (than on-chip memory), since it must be accessed via an interface between the network processor and the SRAM store. Thus, a special memory bus is required for fast access. In some designs, a dedicated back-side bus (BSB) is employed for this purpose. Off-chip SRAM is generally used by modern network processors for storing and processing packet metadata, along with storing other processing-related information.

Typically, various types of off-chip dynamic RAM (DRAM) are employed for use as “bulk” memory. Dynamic RAM is slower than static RAM (due to physical differences in the design and operation of DRAM and SRAM cells), and must be refreshed every few clock cycles, taking up additional overhead. As before, since it is off-chip, it also requires a special bus to access it. In most of today's designs, a bus such as a front-side bus (FSB) is used to enable data transfers between banks of DRAM and a processor. Under a typical design, the FSB connects the processor to a memory control unit in a platform chipset (e.g., memory controller hub (MCH)), while the chipset is connected to memory store, such as DRAM, RDRAM (Rambus DRAM) or DDR DRAM (double data rate), etc. via dedicated signals. As used herein, a memory store comprises one or more memory storage devices having memory spaces that are managed as a common memory space.

In consideration of the foregoing characteristics of the various types of memory, network processors are configured to store packet data in slower bulk memory (e.g., DRAM), while storing metadata in faster memory comprising SRAM. Accordingly, modern network processors usually provide built-in hardware facilities for allocating and managing metadata buffers and access to those buffers in an SRAM store coupled to the network processor. Furthermore, software libraries have been developed to support packet-processing via microengines running on such network processors, wherein the libraries include packet-processing code (i.e., functions) that is configured to access metadata via the built-in hardware facilities.

In some instances, designers may want to employ modern network processors for lower line-rate applications than they are targeted for. One of the motivations for doing so is cost. Network processors, which provide the brains for managing and forwarding network traffic, are very cost-effective. In contrast, some peripheral components, notably SRAM, are relatively expensive. It would be advantageous to reduce the cost of network devices, especially for lower line rate application. However, current network processor hardware and software architectures require the use of SRAM.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a network device architecture illustrating a conventional scheme for implementing packet processing in which packet metadata is stored in a static random access memory (SRAM) store;

FIG. 2 is schematic diagram of an IPv4 (Internet Protocol, version 4) packet;

FIG. 3 is a schematic diagram of a network device architecture illustrating a buffer management scheme in which packet metadata is stored in a dynamic random access memory (DRAM)-based store and SRAM is not employed, according to one embodiment of the invention;

FIG. 3a is a schematic diagram of a variation of the network device architecture of FIG. 3, wherein packet metadata are stored in buffers in a first DRAM-based store, with packet data is stored in buffers in a second DRAM-based store;

FIG. 4 is a schematic diagram illustrating a one-to-one relationship between metadata buffers and packet buffers;

FIG. 5 is a schematic diagram illustrating further details of the network device architecture of FIG. 3, according to one embodiment of the invention;

FIG. 6 is a flowchart illustrating operations and logic performed during a buffer management process implemented via the embodiments of FIGS. 3 and 5, according to one embodiment of the invention; and

FIG. 7 is a block diagram illustrating a software stack that includes a buffer management application program interface (API).

### DETAILED DESCRIPTION OF PREFERRED EMBODIMENTS

Embodiments of methods and apparatus for performing buffer management on network devices without requiring the use of SRAM are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The embodiments described below relate to techniques for managing buffers in network devices without SRAM stores. In connection with the techniques are various schemes for accessing and storing data used for packet processing operations. One of the aspects of the embodiments is that existing software libraries designed for conventional buffer management schemes that employ SRAM stores may be employed under the novel buffer management scheme. In order to better understand and appreciate aspects of the embodiments, a brief description of the configuration and operations of conventional network device architectures now follows.

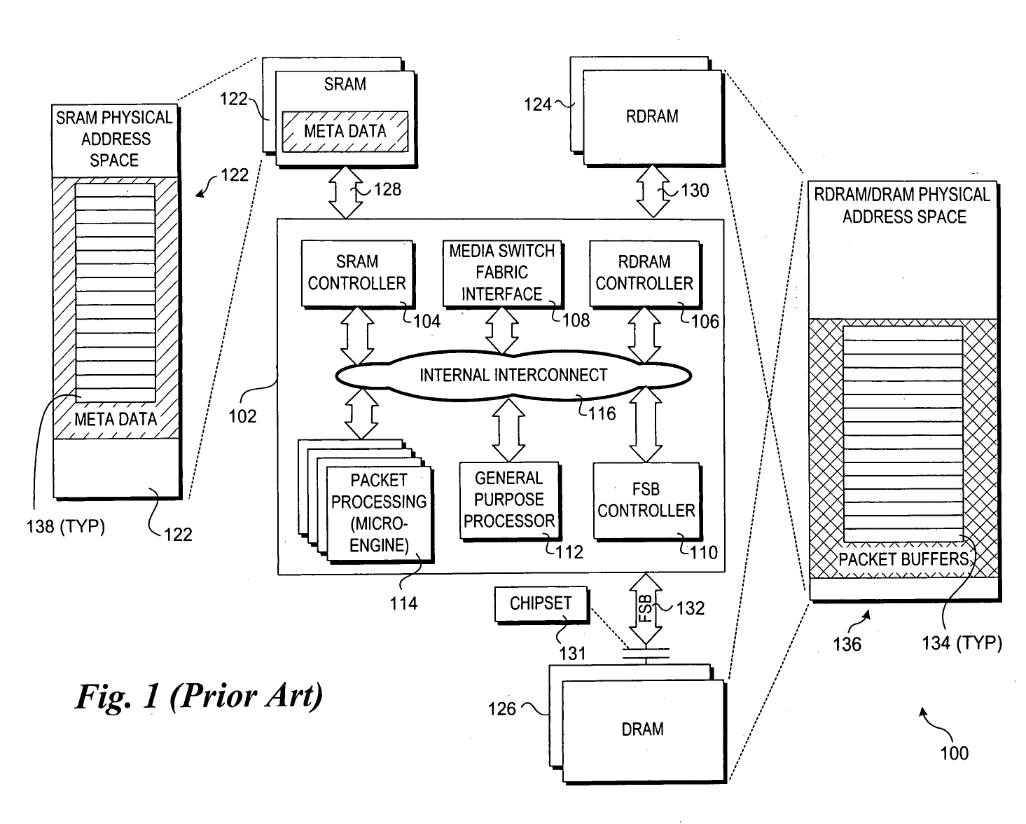

FIG. 1 shows an overview of a conventional network device architecture 100 that supports the use of various types of memory stores. At the heart of the architecture is a network processor 102. The network processor includes an SRAM controller 104, a Rambus DRAM (RDRAM) controller 106, a media switch fabric interface 108, an FSB controller 110, a general-purpose processor 112, and multiple packet processing micro-engines 114. Each of the foregoing components are interconnected via an internal interconnect 116, which represents an appropriate set of address and data buses and control lines (a.k.a., command bus) to support communication between the components.

Network device architecture 100 depicts several memory stores. These include one or more banks of SRAM 122, one or more banks of RDRAM 124, and one or more banks of DRAM 126. Each memory store includes a corresponding physical address space. In one embodiment, SRAM 122 is connected to network processor 102 (and internally to SRAM controller 104) via a high-speed SRAM interface 128. In one embodiment, RDRAM 124 is connected to network processor 102 (and internally to RDRAM controller 106) via a high-speed RDRAM interface 130. In one embodiment, DRAM 126 is connected to a chipset 131, which, in turn, is connected to network processor 102 (and internally to FSB controller 110) via a front-side bus 132 and FSB interface. Under various configurations, either RDRAM 124 alone, DRAM 126 alone, or the combination of the two may be employed for bulk memory purposes.

As depicted herein, RDRAM-related components are illustrative of various components used to support different types of DRAM-based memory stores. These include, but are not limited to RDRAM, RLDRAM (reduced latency DRAM), DDR, DDR-2, DDR-3, and FCDRAM (fast cycle DRAM). It is further noted that a typical implementation may employ either RDRAM or DRAM stores, or a combination of types of DRAM-based memory stores. For clarity, all of these types of DRAM-based memory stores will simply be referred to a “DRAM” stores, although it will be understood that the term “DRAM” may apply to various types of DRAM-based memory.

One of the primary functions performed during packet processing is determining the next hop to which the packet is to be forwarded. A typical network device, such as a switch, includes multiple input and output ports. More accurately, the switch includes multiple input/output (I/O) ports, each of which may function as either an input or an output port within the context of forwarding a given packet. An incoming packet is received at a given I/O port (that functions as in input port), the packet is processed, and the packet is forwarded to its next hop via an appropriate I/O port (that functions as an output port). The switch includes a plurality of cross-connects known as the media switch fabric. The switch fabric connects each I/O port to the other I/O ports. Thus, a switch is enabled to route a packet received at a given I/O port to any of the next hops coupled to the other I/O ports for the switch.

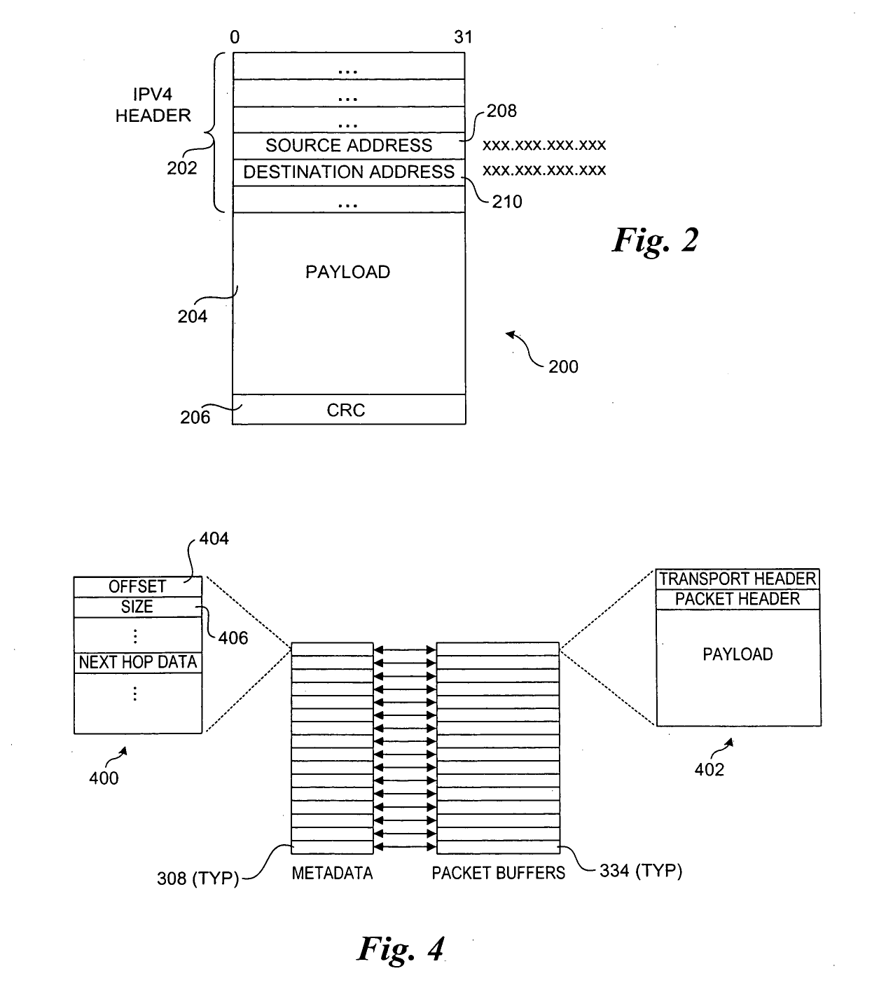

Each packet contains routing information in its header. For example, a conventional IPv4 (Internet Protocol version 4) packet 200 is shown in FIG. 2. The packet data structure includes a header 202, a payload 204, and an optional footer 206. The packet header comprises 5-15 32-bit rows, wherein optional rows occupy rows 6-15. The packet header contains various information for processing the packet, including a source address 208 (i.e., the network address of the network node from which the packet originated) that occupies the fourth row. The packet also includes a destination address, which represents the network address to which the packet is to be forwarded to, and occupies the fifth row; in the illustrated example, a destination address 210 corresponding to a unicast forwarding process is shown. The destination address may also comprise a group destination address, which is used for multicast forwarding. In addition to the source and destination addresses, the packet header also includes information such as the type of service, packet length, identification, protocol, options, etc.

The payload 204 contains the data that is to be delivered via the packet. The length of the payload is variable. The optional footer may contain various types of information, such as a cyclic redundancy check (CRC), which is used to verify the contents of a received packet have not been modified.

In general, packet-processing using modern network processors is accomplished via concurrent execution of multiple threads, wherein each micro-engine may run one or more threads. To coordinate this processing, a sequence of operations is performed to handle each packet that is received at the network device, using a pipelined approach.

The pipelined processing begins by allocating and assigning buffers for each packet that is received. This includes allocation of a packet buffer 134 in a DRAM store 136, and assigning the packet buffer to store data contained in a corresponding packet. Under one conventional scheme, each packet buffer 134 is used to store the entire contents of a packet. Optionally, packet buffers may be used for storing the packet's data payload. Generally, the allocation and assignment of the buffer is not an atomic operation. That is, it does not immediately result from a buffer allocation request. Rather, the requesting process must wait until a buffer is available for allocation and assignment.

In addition to allocation of a packet buffer 134 in DRAM store 136, a metadata buffer 138 is allocated in SRAM store 122 and assigned to the packet. The metadata buffer is used to store metadata that typically includes a buffer descriptor of a corresponding packet buffer, as well as other information that is used for performing control plane and/or data plane processing for the packet. For example, this information may include header type, packet classification, identity, next-hop information, etc. The particular set of metadata will depend on the packet type, e.g., IPv4, IPv6, ATM, etc.

In accordance with one aspect, embodiments of the novel buffer management technique perform packet processing using an architecture that does not require an SRAM store. Additionally, this technique may be used by network processors that support SRAM stores, wherein the SRAM control aspect of the network processor is bypassed. Furthermore, the much or all of the network processor packet-processing code (as that used with the conventional approach) may be employed, wherein the non-existent use of SRAM facilities is transparent to the code.

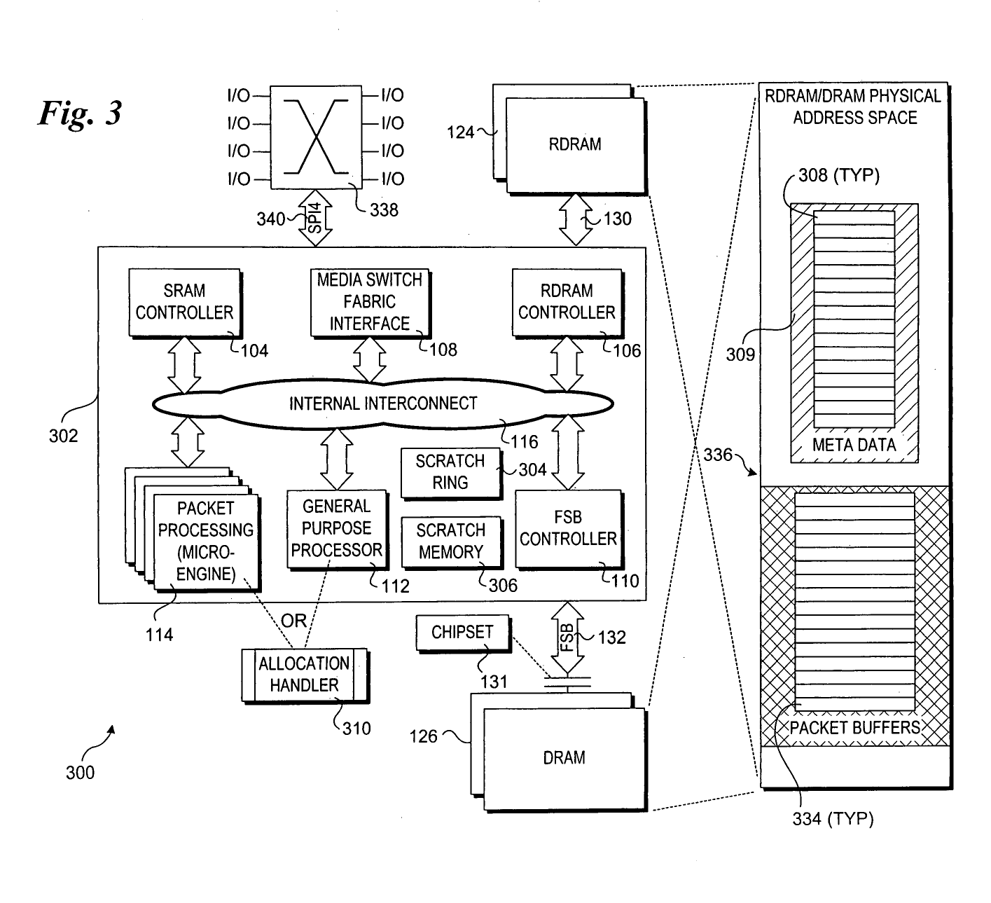

A network device architecture 300 that does not use SRAM, according to one embodiment, is shown in FIG. 3. Architecture 300 includes a network processor 302 that includes similar components to network processor 102 of FIG. 1 having like reference numbers, e.g., micro-engines 114, general-purpose processor 112, etc. In one embodiment, the hardware components of network processor 302 and 102 are identical. In one embodiment, network processor 302 comprises an Intel® IXP2xxx series-network processor.

In addition to the components shown in FIG. 1, network processor 302 includes a scratch ring 304 and scratch memory 306. Network processor 102 may also include a scratch ring and scratch memory; however, the conventional use of scratch rings and scratch memory differs from the use of these components in the embodiments described herein.

As shown toward the right-hand portion of FIG. 3, a DRAM-based store 336 includes a set 309 of metadata buffers 308, in addition to packet buffers 334, which are analogous to packet buffers 134. In general, the metadata stored in metadata buffers 308 is analogous to metadata that is stored in metadata buffers 138 using the conventional approach. The DRAM-based store 336 comprises a memory store that may be hosted by DRAM store 126, RDRAM store 124, or the combination of the two stores.

Additionally, FIG. 3 now shows media switch fabric 338, which is used to cross-connect a plurality of I/O ports in the manner described above. In the illustrated embodiment, the architecture employs a System Packet Interface Level 4 (SPI4) interface 340 between network processor 302 and media switch fabric 338.

Typically, metadata for a given packet will include information from which the location of the corresponding packet (or packet data) may be located. For example, in one embodiment an entire packet's content, including its header(s), is stored in a packet buffer 334, while corresponding metadata is stored in a metadata buffer 308. At the same time, the metadata will generally include information extracted from is corresponding packet, such as its size, routing or next hop information, classification information, etc. As such, packet buffer data and corresponding metadata are interrelated.

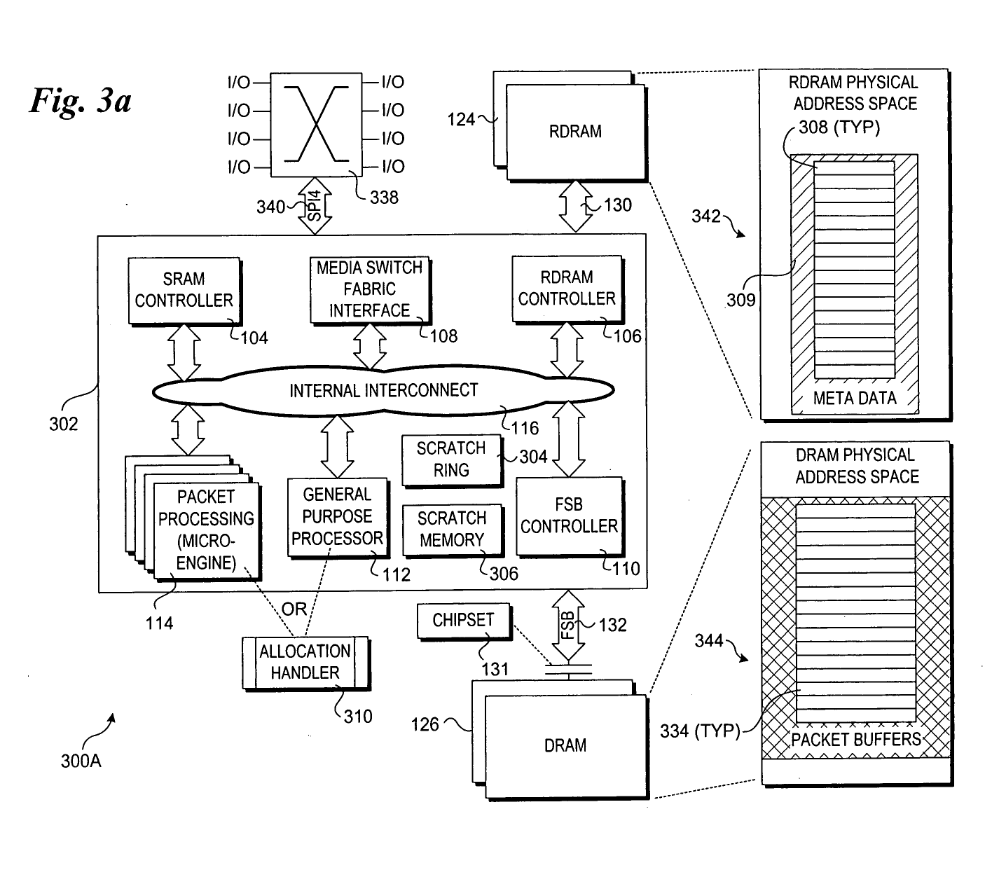

For example, FIG. 4 depicts sets of metadata 400 occupying metadata buffers 308 having a one-to-one relationship with corresponding packet data 402 stored in packet buffers 334. In one embodiment, metadata 400 includes an address offset 404 and a size 406. The address offset is used to identify the location of the starting address (in the physical address space for DRAM-based store 336) of the packet buffer 334 for which the metadata corresponds, while the value of size 406 indicates the size of the packet. In one embodiment, the size refers to the size of the packet in bytes. In one embodiment, the size refers to the number of packet buffers allocated to a give packet. For example, under one embodiment, packet buffers 334 are configured to have a nominal size that is some power of 2, such as 1024 bytes. In some instances, the size of a packet exceeds the nominal size allocated to each packet buffer. As a result, the packet data must be stored in multiple packet buffers. Under one embodiment of the one-to-one relationship shown in FIG. 4, the offset and size data for the metadata stored in the metadata buffers 308 for a packet occupying multiple packet buffers 334 is simply duplicated.

An alternative embodiment comprising network device architecture 300A is shown in FIG. 3a. Under this approach, a first DRAM-based store 342 is used to store metadata buffers 308, while a second DRAM-based store 344 is used to store packet buffers, wherein each of the first and second DRAM-based stores have separate address spaces. Under the illustrated embodiment, RDRAM store 124 is used for the first DRAM-based store 342, while DRAM store 126 is used for second DRAM-based store 344. However, this is merely one combination illustrating and exemplary configuration of first and second DRAM-based stores.

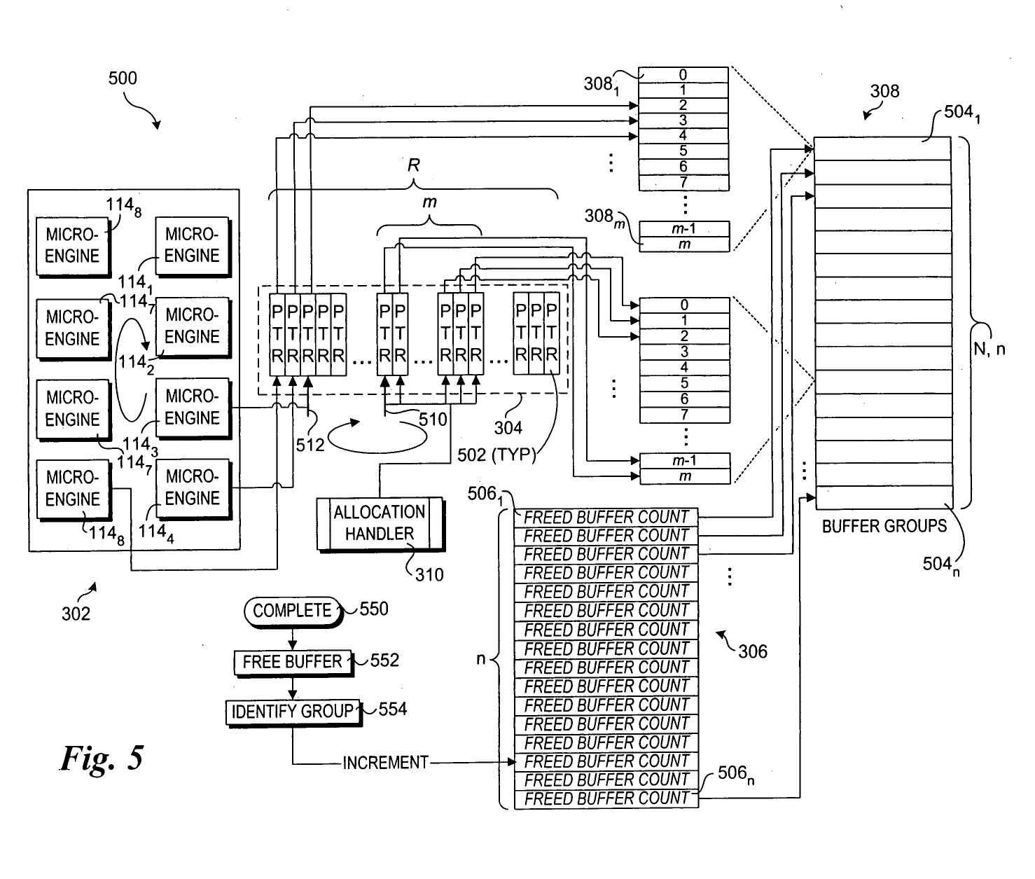

Further details 500 of one embodiment of network device architecture 300 are shown in FIG. 5. In this illustrated example, network processor 302 includes eight microengines 114₁₋₈; in other embodiments, the number of microengines may vary. Each microengine has its own local resources (e.g., registers, local memory, control store, arithmetic logic unit (ALU) etc.), while each microengine is also enabled to access shared resources, such as DRAM store 136 and RDRAM store 130. As discussed above, each microengine executes one or more threads. In one embodiment, each microengine may execute up to eight hardware-based threads. In one embodiment, network processor 302 comprises an Intel® IXP2800 network processors having 16 microengines, and is able to execute up to 512 threads concurrently.

In general, one or more threads will be used to process each packet. For example, using a pipelined architecture, different processing operations for a given packet are handled by respective threads operating (substantially) synchronously. The threads may run on the same microengine, or they may run on different microengines. Furthermore, microengines may be clustered, wherein threads running on a cluster of microengines are used to perform packet-processing on a given packet or packet stream.

Meanwhile, control for processing a given packet may be handled by a given microengine, by a given thread, or by no particular micro-engine or thread. For illustrative purposes, each received packet is “assigned” to a particular microengine in FIG. 5 for packet processing. However, it will be understood that this is merely one exemplary scheme for handling packet-processing. As used herein, buffers are “assigned to packets,” which means access to an assigned buffer is managed by the process used to perform packet-processing operations for that packet. This process may be performed via execution of multiple threads on a single microengine, or execution of multiple threads running on different microengines.

As discussed above, one of the operations performed during packet-processing is the allocation and assignment of buffers. Thus, a network processor employs a mechanism for allocating buffers to microengines (more specifically, to requesting microengine threads) on an ongoing basis. In the network device architecture embodiments of FIG. 3 and 5, this mechanism is provided via an allocation handler 310, which employs scratch ring 304 to maintain pointer data for mapping allocated metadata buffers to their respective locations in DRAM-based store 336. Generally, the allocation handler is an asynchronous process that operates separately from microengine packet-processing threads. In one embodiment, allocation handler 310 runs on general-purpose processor 112. In another embodiment, allocation handler 310 comprises a thread running on one of microengines 114₁₋₈.

The purpose of scratch ring 304 is to allocate and reserve buffers for subsequent assignment to microengines 114₁₋₈ on an ongoing basis. In one embodiment, the various buffer resources are allocated using a round-robin or “ring” basis, thus the name “scratch ring.” The number “R” of scratch ring entries 502 in scratch ring 304 will generally depend on the number of buffers that are allocated in view of the packet processing speed (e.g., line-rate) requirements and the number of microengines and/or microengine threads supported by the network processor. Similarly, the total number of buffers to be allocated will likewise depend on the processing speed requirements and the number of network processor micro-engines and/or microengine threads.

Overall, the number of packet buffers and metadata buffers that are hosted by DRAM-based store 336 is “N.” For example, in one embodiment N=1024 buffers. The N buffers are divided into “n” groups 504₁₋ₙ, each including “m” buffers, wherein N=n×m. In one embodiment, n=16 and m=64. In scratch memory 306, n long words (e.g., 32-bit) are allocated to keep the status (freed buffer count) of each buffer group, as depicted by freed buffer count entries 506₁₋ₙ. In one embodiment, each freed buffer count entry 506 is initialized with a value m.

In one embodiment, the buffers are managed in the following manner. The metadata buffers 308₁₋ₘ in a buffer group 504 are allocated as a group, on a sequential basis. In connection with the allocation of a metadata buffer, a corresponding pointer (PTR) 502 is added to scratch ring 304 to locate the buffer. A buffer allocation marker 510 is used to mark the pointer 502 used to locate the next buffer to be allocated. Thus, the allocation of each buffer group will advance buffer allocation marker 510 m entries in scratch ring 304.

In general, previously allocated metadata buffers (and corresponding packet buffers—not shown) will be assigned to packets by assigning the metadata buffer to threads running on microengines 114. Accordingly, a next buffer assignment marker 512 is used to mark the next buffer to be assigned to a microengine (thread). As each new buffer request is received, a new buffer assignment is made, causing the next buffer assignment marker 512 to be incremented by one. When either of the buffer allocation marker 510 or the next buffer assignment marker 510 equals R, the corresponding marker is rolled over back to 1, resetting the marker to the beginning of the scratch ring.

After a metadata buffer has been used, it is freed (i.e., released for use by another consumer). In one respect, it is desired to make the effect of a buffer release immediate—that is, an atomic operation, thus enabling the thread releasing the buffer to immediately proceed to its next operation without any wait time. This is to mirror the behavior of the conventional SRAM usage for metadata buffers. Accordingly, in one embodiment, the release operation is atomic.

This is achieved in the following manner. At the completion of packet-processing operations for a given packet (as depicted by a return block 550), the metadata buffer is freed in a block 552. The group to which the buffer corresponds is then identified in a block 554, and the freed buffer count for that group is incremented by 1. The purpose for incrementing the freed buffer count is described below.

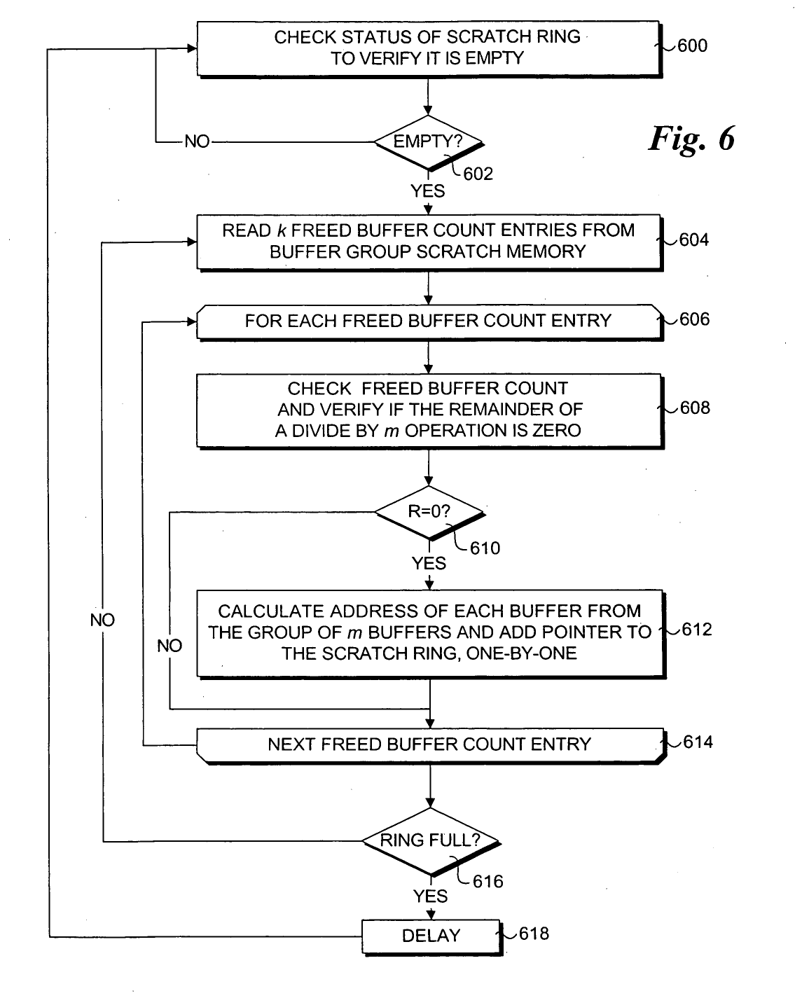

Further details of one embodiment of the buffer management process is shown in the flowchart of FIG. 6. In the embodiment, the allocation handler thread runs the logic of buffer management in a while loop using predetermined time interval. In one embodiment, the allocation handler logic is run as a functional pipeline in connection with packet-processing operations performed by some other microblock, where processing time is deterministic.

The process beings in a block 600, wherein the status of the scratch ring is checked to verify it is empty. This process is repeated on an interval basis until the scratch ring is verified as empty, as depicted by a decision block 602. In response to empty condition, k freed buffer count entries 506₁₋ₙ are read from scratch memory 306. The operations defined between start and end loop blocks 606 and 614 are then performed for each freed buffer count entry.

In one embodiment, no new buffer allocations for a given buffer group may be initiated until the freed buffer count is equal to a value that is evenly divisible by m. Accordingly, in a block 608, the freed buffer count is checked to verify if the remainder of a divide by m operation performed on the count (e.g., modulus(freed buffer count, m) is zero. In the foregoing example, m=64. Thus, until modulus(freed buffer count, 64)=0 (the remainder of m divided by 64 equals 0) for a given group, no new buffers are allocated for that group, even if some of the buffers for a group have been freed. If modulus(freed buffer count, m)=0, the answer to decision block 610 is YES (TRUE), and the logic proceeds to a block 612. In this block, the address of each of m buffers from the group (corresponding to the freed buffer count entry being currently evaluated) is calculated, and a corresponding pointer is added to scratch ring 304, one-by-one, resulting in m pointers being added to scratch ring 304. The process then loops back to perform the operations of blocks 608, 610, and 612 on the next freed buffer count entry. If the remainder of the divide by m operation in block 608 is not 0, all the buffers for the group have not been freed, and the logic skips the operation of block 612 and proceeds to processing the next freed buffer count entry.

Once all of the k buffer group entries have been processed, a determination is made in a decision block 616 to whether the scratch ring is full or not. If it is not full, the logic loops back to block 604 to read k more freed buffer count entries, and the processing of these new entries is performed. If the scratch ring is full, the logic proceeds to a delay block 618, which imparts a processing delay prior to returning to block 604.

As discussed above, another aspect of the embodiments is code transparency. That is, the same software that was designed to be used on a network processor that employs SRAM for storing metadata using the conventional approach may be used on network devices employing the buffer management techniques disclosed herein, without requiring any modification. This is advantageous, as a significant amount of code has been written for network processors based on existing libraries.

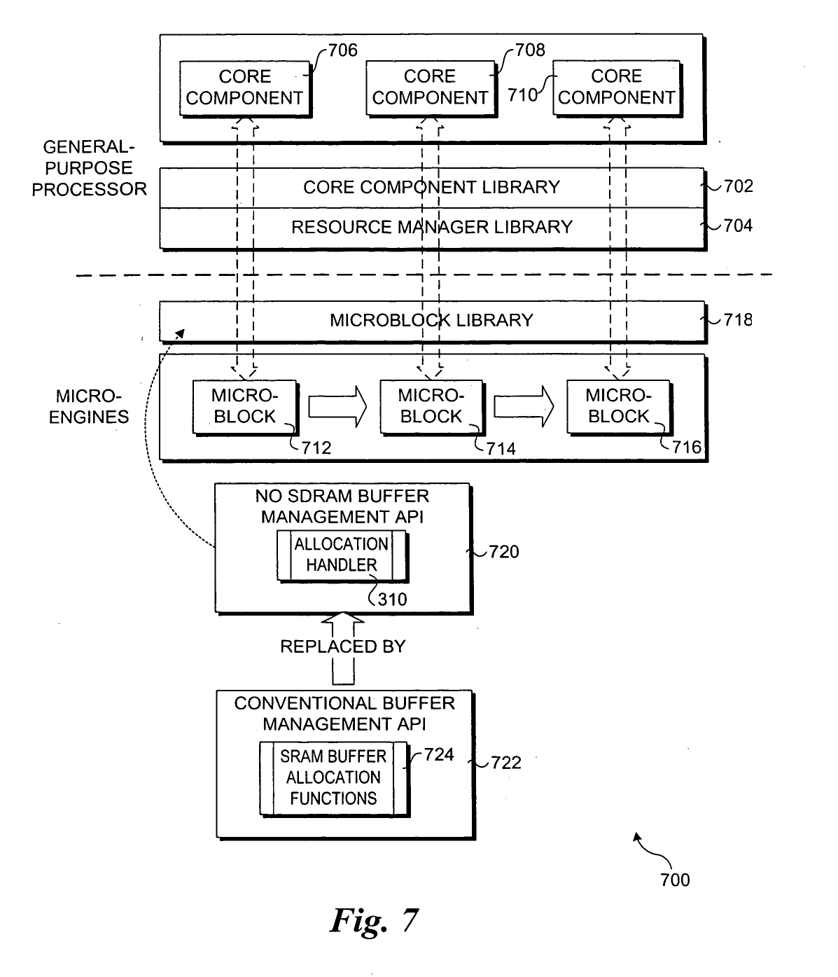

FIG. 7 shows a software architecture 700 (i.e., software stack) that may be implemented using the network device architecture of FIGS. 3, 3a, and 5, according to one embodiment. The software architecture is distributed across multiple processor types, wherein the upper portion of the architecture pertains to components that run on a general-purpose processor (hosted by the network processor), with the lower portion of the architecture pertains to components that run on the network processor's microengines.

The components that run on the general-purpose processor (which is also referred to as the “core”) include a core component library 702 and a resource manager library 704. These libraries comprise the network processor's core libraries, which are typically written by the manufacturer of the network processor. Software comprising code components 706, 708, and 710 generally include packet-processing code that is run on the general-purpose processor. Portions of this code may generally be written by the manufacturer, a third party, or an end user.

The core components 706, 708 and 710 are used to interact with microblocks 712, 714, and 716, which execute on the network processor microengines. The microblocks are used to perform packet-processing operations using a pipelined approach, wherein data plane packet processing on the microengines is divided into logical function called microblocks. Several microblocks running on a microengine thread may be combined into a microgroup block. Each microblock group has a dispatch loop that defines the dataflow for packets between microblocks.

As before, portions of the code for microblocks 712, 714 and 716 may generally be written by the manufacturer, a third party, or an end user. To support common functionality, a microblock library 718 is provided (generally by the manufacturer). The microblock library contains various functions that are called by microblock code to perform corresponding packet-processing operations.

One of these operations is buffer management. In one embodiment, microblock library 718 includes a no SDRAM buffer management application program interface (API) 720, comprising a set of callable functions that are used to facilitate the buffer management operations described herein. This API includes functions that are used to effect the operations of allocation handler 310 described above.

In view of code transparency considerations, the callable function names and parameters corresponding to the functions provided by no SDRAM buffer management API 720 are identical to the function names and parameters used by a conventional buffer management API 722 that is used for performing buffer management functions that employ SRAM to store metadata buffers, as depicted by SRAM buffer allocation functions 724. Thus, by replacing convention buffer management API 720 with no SRAM buffer management API 720, buffer management operations that do not employ SRAM are facilitated by microblock library 718 in a manner that is transparent to packet processing code employed by microblocks 712, 714, and 716.

Generally, the operations in the flowcharts and architecture diagrams described above will be facilitated, at least in part, by execution of threads (i.e., instructions) running on micro-engines and general-purpose processors or the like. Thus, embodiments of this invention may be used as or to support a software program and/or modules or the like executed upon some form of processing core (such as a general-purpose processor or micro-engine) or otherwise implemented or realized upon or within a machine-readable medium. A machine-readable medium includes any mechanism for storing or transmitting information in a form readable by a machine (e.g., a processor). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
allocating metadata buffers in a dynamic random access memory-(DRAM)-based memory store; and
assigning each metadata buffer to a store metadata corresponding to a respective packet to be processed by a network processor,
wherein the metadata buffers are allocated using a software-based mechanism running on the network processor.

2. The method of claim 1, wherein the network processor includes built-in hardware facilities to store metadata buffers in an SRAM memory store.

3. The method of claim 2, wherein the network processor comprises an Intel IXP2xxx series network processor.

4. The method of claim 1, further comprising:
allocating packet buffers in a DRAM-based memory store; and
assigning each packet buffer to store data corresponding a respective packet.

5. The method of claim 4, further comprising:
storing the metadata buffers in a first DRAM-based memory store; and
storing the packet buffers in a second DRAM-based memory store.

6. The method of claim 1, further comprising:
employing a scratch ring on the network processor to store information identifying locations of at least a portion of the metadata buffers that are allocated.

7. The method of claim 1, further comprising:
configuring storage of metadata buffers in the DRAM-based store into groups of metadata buffers; and
allocating metadata buffers in groups.

8. The method of claim 7, further comprising:
maintaining information indicating if any metadata buffers in a given group are not free to be allocated; and
allocating a group of metadata buffers corresponding to the given group if it is determined that all metadata buffers in the given group are free to be allocated.

9. The method of claim 8, further comprising:
maintaining the information indicating if any metadata buffers in a given group are not free to be allocated in a portion of scratch memory onboard the network processor.

10. The method of claim 8, further comprising:
allocating buffers in groups of m buffers;
maintaining a count of freed metadata buffers for each group, wherein a freed metadata buffer comprises a metadata buffer that has been freed in conjunction with completing metadata-related processing operations for a packet to which the metadata buffer was assigned; and
determining if all metadata buffers for a given group are free by verifying the count of freed metadata buffers is evenly divisible by m.

11. The method of claim 1, further comprising:
enabling a metadata buffer to be freed using an atomic operation.

12. The method of claim 1, wherein the network processor includes a plurality of microengines and there exists a standardized library comprising packet-processing code that is designed to be executed on the microengines to perform packet processing operations, the method further comprising:
employing the software-based mechanism to allocate metadata buffers in the DRAM-based memory store in a manner that is transparent to the packet-processing code.

13. The method of claim 12, wherein the software-based mechanism to allocate metadata buffers includes an allocation handler and the network processor includes a general-purpose processor, the method further comprising:
executing the allocation handler as a thread running on the general-purpose processor.

14. The method of claim 12, wherein the software-based mechanism to allocate metadata buffers includes an allocation handler, the method further comprising:
executing the allocation handler as a thread running on one of the plurality of microengines.

15. An article of manufacture, comprising:
a machine-readable medium that provides instructions that, if executed by a network processor, will perform operations comprising,
allocating metadata buffers in a dynamic random access memory-(DRAM)-based memory store accessed via the network processor; and
receiving a request from a requester to assign a metadata buffer for use by packet-processing operations performed by the network processor in connection with processing a packet received by the network processor; and
assigning a metadata buffer to the requester.

16. The article of manufacture of claim 15, including further instructions to perform operations comprising:
allocating a packet buffer in a DRAM-based memory store accessible to the network processor; and
assigning the packet buffer to store data contained in the packet.

17. The article of manufacture of claim 15, including further instructions to perform operations comprising:
storing the metadata buffers in a first DRAM-based memory store; and
storing the packet buffers in a second DRAM-based memory store.

18. The article of manufacture of claim 15, including further instructions to perform operations comprising:
storing a pointer in a scratch ring on the network processor in connection with allocating a metadata buffer, the pointer pointing to a location of the metadata buffer in the DRAM-based memory store.

19. The article of manufacture of claim 15, including further instructions to perform operations comprising:
configuring storage of metadata buffers in the DRAM-based store into groups of metadata buffers; and
allocating metadata buffers in groups.

20. The article of manufacture of claim 19, including further instructions to perform operations comprising:
maintaining information indicating if any metadata buffers in a given group are not free to be allocated; and
allocating a group of metadata buffers corresponding to the given group if it is determined that all metadata buffers in the given group are free to be allocated.

21. The article of manufacture of claim 20, including further instructions to perform operations comprising:
allocating an address space in the first DRAM-based store to store a plurality of groups of m buffers;
maintaining a count of freed metadata buffers for each group, wherein a freed metadata buffer comprises a metadata buffer that has been freed in conjunction with completing metadata-related processing operations for a packet to which the metadata buffer was assigned; and
determining if all metadata buffers for a given group are free by verifying the count of freed metadata buffers is evenly divisible by m; and in response thereto,
allocating a group of m buffers.

22. The article of manufacture of claim 15, wherein the network processor includes a general-purpose processor and the instructions are embodied as an allocation handler that is executed on the general purpose processor.

23. The article of manufacture of claim 15, wherein the network processor includes a plurality of microengines, and the instructions are embodied as an allocation handler that is executed as a thread on one of the microengines.

24. The article of manufacture of claim 15, wherein the network processor comprises an Intel IXP2xxx series network processor.

25. The article of manufacture of claim 15, wherein at least a portion of the instructions are embodied as a buffer management application program interface (API) to be employed in a microblock library for the network processor.

26. The article of manufacture of claim 25, wherein the machine-readable medium further includes callable microblock code corresponding to a microblock library for the network processor.

27. A network apparatus, comprising:
a network processor including a plurality of micro-engines and a media switch fabric interface;
a first dynamic random access memory (DRAM)-based store, operatively coupled to the network processor;
media switch fabric, including cross-over connections between a plurality of input/output (I/O) ports via which packets are received at and forwarded from; and
a plurality of instructions, accessible to the network processor, which if executed by the network processor perform operations including,
allocating metadata buffers in the first DRAM-based store;
receiving a request from a thread executing on one of the microengines to assign an metadata buffer to the thread, the metadata buffer to store metadata used by packet-processing operations performed by the network processor in connection with processing a packet received by the network processor; and
assigning a metadata buffer to the thread.

28. The network apparatus of claim 27, further comprising:
a scratch ring, hosted by the network processor, to store pointers identifying respective locations of metadata buffers in the DRAM-based store.

29. The network apparatus of claim 27, further comprising:
scratch memory, hosted by the network processor,
and wherein execution of the instructions performs the further operations of,
allocating an address space in the first DRAM-based store to store a plurality of groups of m buffers;
allocating a portion of the scratch memory to store m freed metadata buffer counters;
maintaining a count of freed metadata buffers for each group in a corresponding freed metadata buffer counter, wherein a freed metadata buffer comprises a metadata buffer that has been freed in conjunction with completing metadata-related processing operations for a packet to which the metadata buffer was assigned; and
determining if all metadata buffers for a given group are free by verifying the count of freed metadata buffers for the group is evenly divisible by m; and in response thereto,
allocating a group of m buffers.

30. The network apparatus of claim 27, further comprising:
a second DRAM-based store, operatively coupled to the network processor; and wherein execution of the instructions performs further operations including,
allocating a packet buffer in the second DRAM-based memory store;
assigning the packet buffer to store data contained in the packet; and
copying data contained in the packet to the packet buffer.
